(19) United States
(12) Patent Application Publication
(10) Pub. No.: US 2005/0210416 A1
(43) Pub. Date: Sep. 22, 2005

(54) Interactive preview of group contents via axial controller

(76) Inventors: Matthew B. MacLaurin, Woodinville, WA (US); Andrzej Turski, Redmond, WA (US)

Correspondence Address: AMIN & TUROCY, LLP, 24TH FLOOR, NATIONAL CITY CENTER, 1900 EAST NINTH STREET, CLEVELAND, OH, 44114, US

(21) Appl. No.: 10/801,799

(22) Filed: Mar. 16, 2004

(51) Int. Cl. G06F 3/00

(52) U.S. Cl. 715/851; 715/855; 715/776; 715/712; 715/793; 715/834; 715/833; 715/817; 715/830; 715/821; 715/711

(57) ABSTRACT

The present invention relates to a system and method to facilitate rendering of a collection of display items such as a collection of document sheets appearing under a singular display icon or object. In one aspect, a system is provided for displaying item collection previews. The system includes at least one display object having metadata tags that describe two or more data items in a collection of data items. A control component selectively animates a presentation of the items based in part on the metadata tags and detected user activities. When a display object is selected, users can scroll through pages or items in a stack, whereby transitional displays can be provided during scrolling operations.

### TECHNICAL FIELD

The present invention relates generally to computer systems and more particularly, the present invention relates to systems and methods that enable users to interactively preview contents of a group via an axial interface controller.

### BACKGROUND OF THE INVENTION

Various graphical user interfaces have been developed to provide an interactive framework for computer users. Computer programs typically provide a graphical user interface (GUI) to facilitate data entry, to enable viewing output on a display screen, as well as to manipulate or rearrange data. A graphical user interface can be associated with an application program or operating system shell, which may be running on a user's local machine and/or remotely, such as in a distributing computing system or over the Internet. In view of continuing technological developments and increasing use of the Internet, people are using computers to access information to an ever-increasing extent. Such information can reside locally on the person's computer or within a local network or be global in scope, such as over the Internet.

Users of window-based graphical user interfaces face difficult problems when they employ various programs for multiple tasks or activities—they often have a large number of windows to manage, with many windows for each task. Switching between tasks is difficult because the windows often can be scattered across the desktop display. Moreover, if windows are minimized while not in use, they are typically not organized together. If not minimized, a user can be faced with a difficult task of locating all relevant obscured windows and bringing them to a top of a display. Furthermore, content within a window such as application icons, document sheets, presentation slides and so forth continue to clutter the user's workspace which tends to decrease productivity.

When users begin employing large display configurations (e.g., multiple monitors), managing windows and tasks becomes an ever more difficult problem. Managing many display objects on small displays (e.g., PDA's) is also difficult—in such case, oftentimes sufficient screen space is not available to display objects of interest.

As the amount of information content grows, another problem faced by users is that they are often forced to perform combinations of searching and browsing to identify information items of interest. Thus, users need more efficient means to discriminate the target items they are pursuing. Also, as the complexity of each item grows, users may desire to have more efficient access into portions of the items, without having to necessarily open an item in a fully-opened application in order to do so. Although various attempts have been made via conventional user interface schemes to address some of the aforementioned concerns, there is still a substantial unmet need for a system and/or methodology that facilitates efficient use of valuable computer user's time and cognitive resources in a multi-task working environment.

In one example, folders are well-established user interface constructs representing collections of items. In some systems, these collections are supplemented by stacks or dynamically generated document groups. Both types of groups represent collections of an arbitrary number of documents, yet may appear as a single icon to the user. While such constructs make it easier to manipulate the group as a whole, they make it more difficult to view the individual items that make up the view.

### SUMMARY OF THE INVENTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

The present invention relates to systems and methods that facilitate previewing content of stacked or grouped information displays in an efficient manner. Dynamically-generated collections of documents or files can be represented as single icons or entities, and form part of the next generation file system user interfaces. The subject invention provides an improved method for navigating the collection via an axial user interface controller such as a mouse wheel, for example, to interactively preview the contents of a group (such as a folder) in order to observe or review individual elements of the collection without navigating into (e.g., double-clicking) the collection. In one example aspect, the user moves a mouse cursor over a collection icon and a small preview image of the first document or page in the collection is shown. The user may then increment or decrement the axial controller to display the next (or former) document preview icon. A transitional animation can be employed to visually link the movement of the axial controller with the change in the displayed icon, wherein the user can quickly “flip” or scroll through many document previews quickly. When the user moves the curser away from the collection icon, the currently selected preview image can be integrated with the collection icon as a reminder of collection contents.

To the accomplishment of the foregoing and related ends, certain illustrative aspects of the invention are described herein in connection with the following description and the annexed drawings. These aspects are indicative of various ways in which the invention may be practiced, all of which are intended to be covered by the present invention. Other advantages and novel features of the invention may become apparent from the following detailed description of the invention when considered in conjunction with the drawings.

### BRIEF DESCRIPTION OF THE DRAWINGS

FIG. 1 is a schematic block diagram illustrating an axial control system in accordance with an aspect of the present invention.

FIG. 2 is a diagram illustrating an exemplary control and rendering sequence for collection previews in accordance with an aspect of the present invention.

FIG. 3 is a diagram illustrating item tags in accordance with an aspect of the present invention.

FIG. 4 is a diagram illustrating global collection processing in accordance with an aspect of the present invention.

FIG. 5 illustrates collection rendering and scrolling options in accordance with an aspect of the present invention.

FIG. 6 illustrates alternative control options in accordance with an aspect of the present invention.

FIG. 7 is a flow diagram illustrating axial control processing in accordance with an aspect of the present invention.

FIG. 8 is a schematic block diagram illustrating a suitable operating environment in accordance with an aspect of the present invention.

FIG. 9 is a schematic block diagram of a sample-computing environment with which the present invention can interact.

### DETAILED DESCRIPTION OF THE INVENTION

The present invention relates to a system and method to facilitate rendering of a collection of display items such as a collection of document sheets appearing under a singular display icon or object. In one aspect, a system is provided for displaying item collection previews. The system includes at least one display object having metadata tags that describe two or more data items in a collection of data items. A control component selectively animates a presentation of the items based in part on the metadata tags and detected user activities (e.g., mouse movement, mouse wheel, voice commands). When a display object is selected, users can scroll through pages or items in a stack of items, whereby transitional displays can be provided during scrolling operations (e.g., show portions of one page and portions of a subsequent page while scrolling between pages).

As used in this application, the terms “component,” “controller,” “object,” “system,” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers. Also, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal).

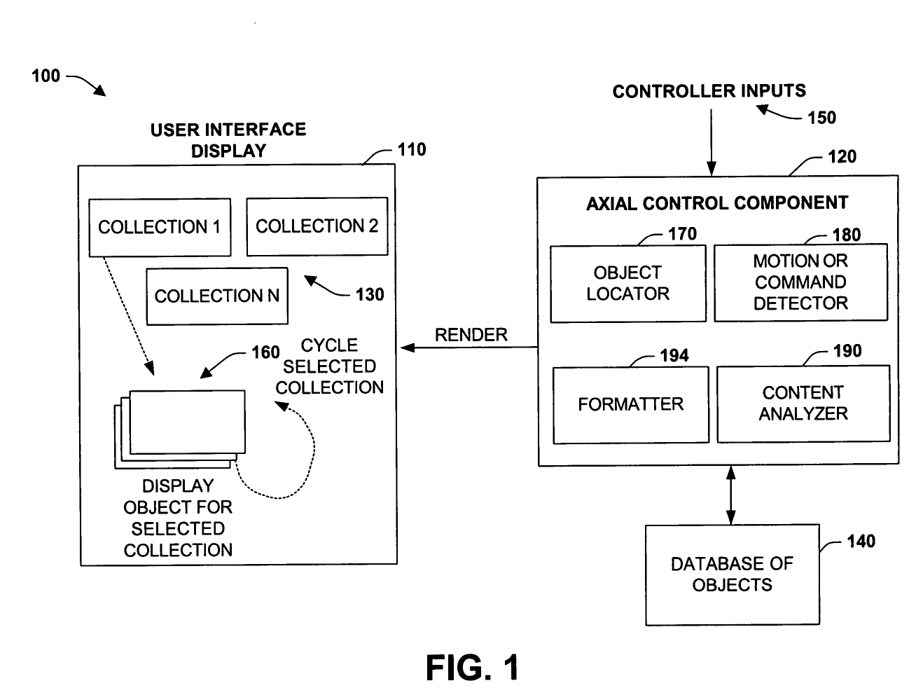

Referring initially to FIG. 1, an axial control system 100 is illustrated in accordance with an aspect of the present invention. The system 100 includes a user interface display 110 and an axial control component 120 (ACC) for rendering and previewing display objects as one or more collections of items 130. The ACC 120 and collections 130 can process or include various dimensions, shapes, user controls, sizing, groupings, content renderings, and other aspects for interacting with the collections (e.g., metadata and control parameters) including subcomponents of processed items for controlling the display of information to the user. The collections of items 130 are normally stored in a local and/or remote database 140 that can be accessed by the ACC 120.

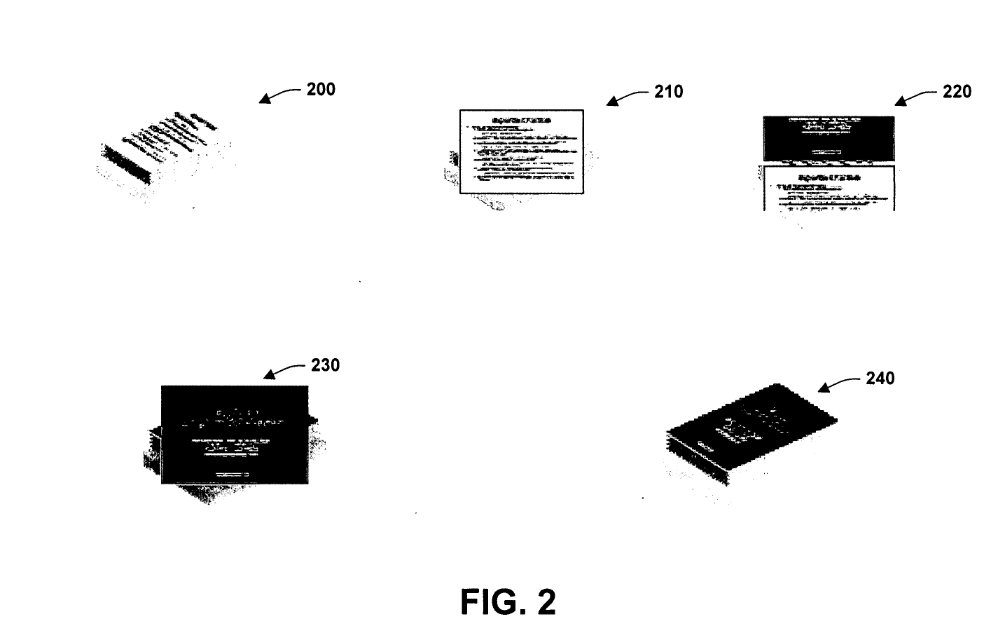

In one aspect, a user employs controller inputs 150 such as a mouse control or other type command (e.g., voice command, eye-gaze controls) to select a collection of items 130. Typically, the top display of a collection can be a thumbnail preview of one of the items in the collection. For instance, a collection, is selected via a mouse-over action from the controller inputs 150, as illustrated at 160 (shown at another location for illustrative purposes). A user can then supply a subsequent control input 150 (referred to as axial control) such as a mouse wheel for example, to cycle through the collection of items. As items are cycled at 160, subsequent previews corresponding to the cycled items are displayed. The ACC 120 also includes rendering controls to gradually or partially cycle/transition items through preview as will be described in more detail below with respect to FIG. 2.

It is noted that the system 100 generally involves a two-fold user action. In the first action, the user moves a mouse cursor (or other control) over the collection 130. In response, the system shows a small preview image of the first document in the collection as illustrated at 160. The user may then increment or decrement the controller input 150 (with respect to axial controller, a user input device capable of incrementing and decrementing a value—in one example implementation, a mouse wheel). With each change in the value of the controller input 150, the next (or former) document preview icon can be displayed. A transitional animation can be employed to visually link the movement of the axial controller with the change in the displayed icon. Thus, the user can quickly “flip” through many document previews quickly and efficiently. When the user then moves the cursor away from the collection, the currently selected preview image can be integrated with the collection icon as a reminder of the collection contents.

Other components in the ACC 120 for cycling and rendering collections include an object locator 170 for detecting when a collection of items has been selected and a motion or command detector 180 to cycle through the selected collection. A content analyzer 190 includes rendering controls and also reads/processes collections and respective items from the database 140, whereas a formatter 194 drives the user interface display 110.

The user interface 160 can be provided as part of the graphical user interface in association with the ACC 120 and database 140 and can be provided as part of and/or in association with a display. The display can be configured via interfaces regarding various aspects of display or content preferences, configurations and/or desired information formatting by the user. The display can include display objects (e.g., icons, buttons, sliders, input boxes, selection options, menus, tabs, and so forth) having multiple dimensions, shapes, colors, text, data and sounds to facilitate optimal control, sizing/resizing, format and/or display of the collections 130. In addition, various menus and alternative screens or display outputs can be provided that perform a plurality of aspects of the present invention. These aspects can also include a plurality of inputs for adjusting and configuring one or more aspects of the present invention. This can include receiving user commands from a mouse, keyboard, speech input and/or other device to effect operations of the display via an associated graphical user interface. Also, users can be provided with a set of preference controls that can change, by type of item, the rich preview visualizations and access behaviors associated therewith. The system 100 can also be coupled with offline, or real-time analysis (using principles of continual computation), and caching of the rendered results so as to minimize latencies in real time.

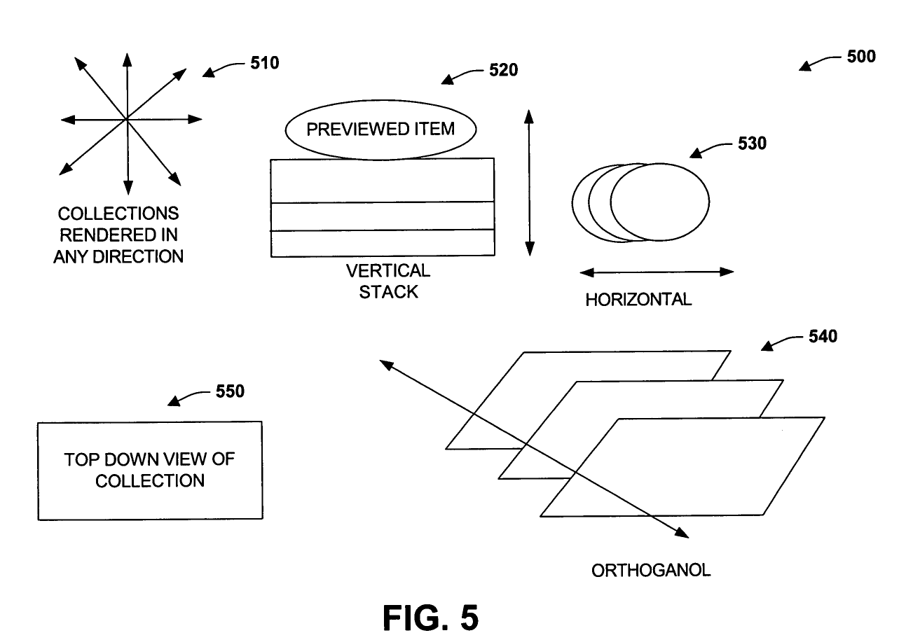

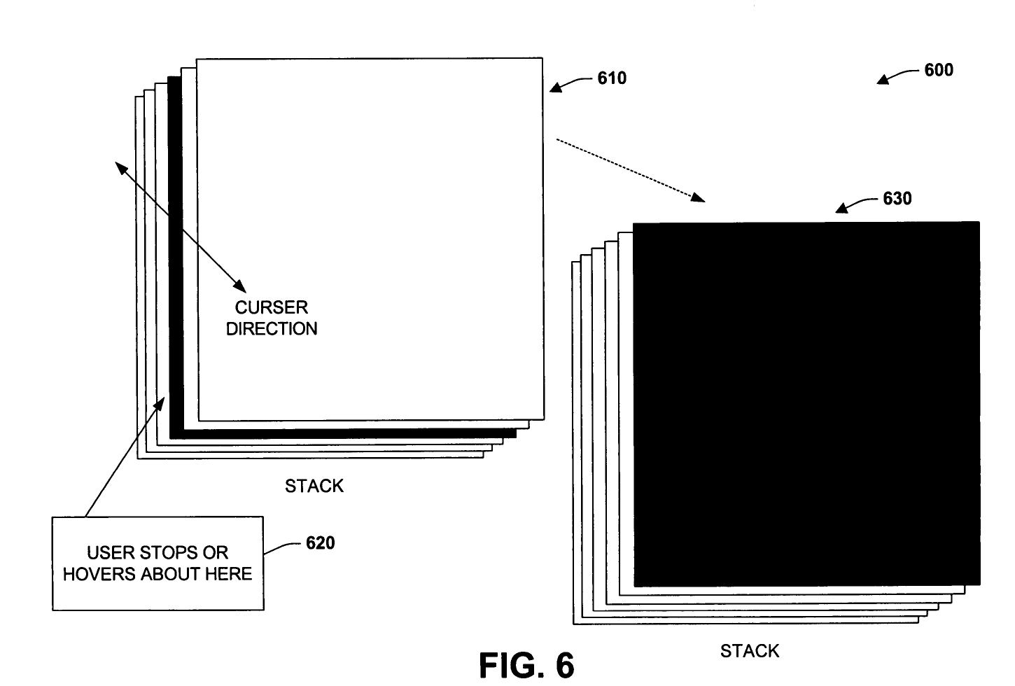

FIG. 2 is a diagram illustrating an exemplary control and rendering sequence for collection previews in accordance with an aspect of the present invention. In this aspect, a collection of item subcomponents (e.g., pages of a text document) are rendered in various formats at a display. This can include rendering portions of a document and/or selecting various subcomponents and portions relating to a selected subcomponent. It is to be appreciated that various renderings styles and controls are possible in addition to the examples depicted in FIG. 2. Some of these aspects are described in more detail in the discussion relating to FIGS. 5 and 6.

At 200, a stack of items is illustrated (e.g., PowerPoint or Word documents). During a mouse over state at 210, the top document preview appears. At 230, transitional animation is displayed as the user moves a mouse wheel down (or other type control such as a voice command). After a completed transition at 240, a new preview is shown. If other axial controls are detected, subsequent items in the stack are then displayed. At 250, the user moves the cursor away and the new preview from 240 is left atop the stack in this example.

Initial document collections may appear as a text identifier or thumbnail views, yet user controls can enable the top document or item scrolled to be displayed in a larger or alternative view than other members of the collection. Document or items can be displayed in an isometric three-space representation, decomposed into a set of pages comprising the document, sequenced from front to back or other order. Key pages, e.g., the initial page of the document might be further “exploded,” highlighting key content, such as figures, graphics and links. Special pages, like the last page that was edited or pages where most of the recent work has occurred may be highlighted via overall enlargement, being pulled out of a stack in one or more ways. Such pages may also be decomposed via highlighting into components that were pre-existing and components that were last generated. Users can mouse-over different regions to expand, move, and inspect additional details. Clicking on components or sub-details can invoke the appropriate application software to execute and bring the document up at a particular place noted by the user as described further with respect to FIG. 6.

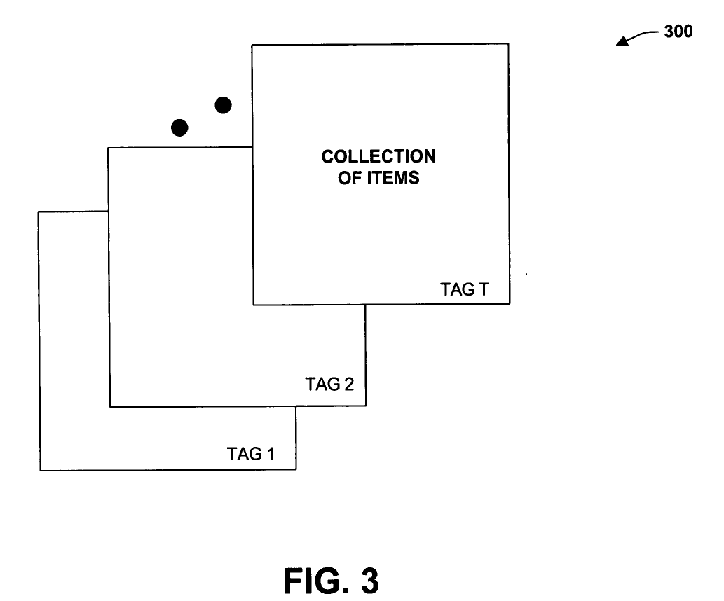

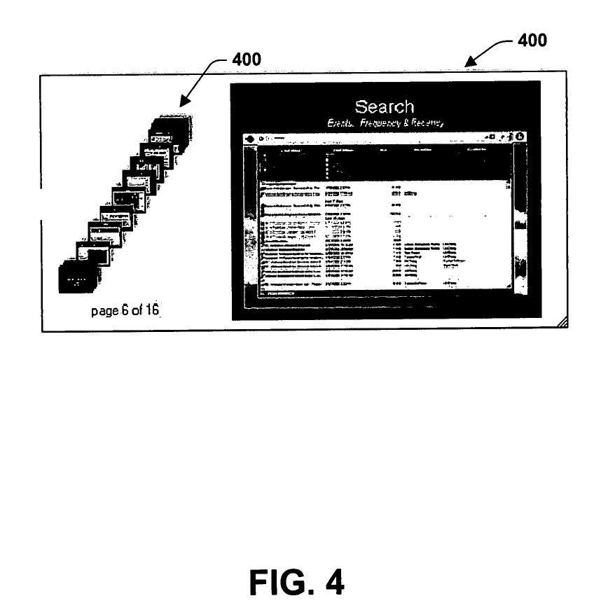

Turning to FIG. 3, a document collection 300 and associated tags are illustrated in accordance with an aspect of the present invention. In this aspect, a collection 300 of documents, sheets, files, or items is depicted having a plurality of members in the collection. As illustrated, respective members can be associated with a metadata tag illustrated as tags 1 through T, T being an integer. Thus, when the collection 300 is selected, items in the collection can be indexed, processed and cycled for display via the metadata tags. In general, the members of the collection 300 may have a similar relationship such as pages of a document file or sheets of a presentation file. However, this type collection arrangement is merely an example of such collection 300 as will described in more detail with respect to FIG. 4.

At preview time at the collection 300, an item at focus can be rendered in a rich geometrical layout, employing renderings and animations employing two- or three-dimensional graphics. The visualizations can be a function of one or more of properties associated with the type of item, item structure, item content, and metadata about the history of interaction with the item. Users can browse components of the items, at times, selectively zooming with a mouse and keyboard (or other input device) on subcomponents, in a graphical and/or semantic manner, and also executing more traditional applications in new ways. As an example, a user can see visually, the last page that was edited and can bring that page up to the immediate foreground, if desired.

It is noted, that the collection 300 can include information items having one or more items or item subcomponents which are graphically displayed along an axis of rendering. Respective items or subcomponents may have various portions for providing more detailed information such as graphics, text, embedded audio and/or image files, and so forth. It is to be appreciated that although rectangular components are illustrated, information can be rendered in substantially any size shape, color, dimension, and so forth as described in more detail with respect to FIG. 5.

FIG. 4 is a diagram illustrating global collection processing in accordance with an aspect of the present invention. The collection concepts described above in FIG. 3 can be expanded to include other type collections. For example, a group of unrelated files, folders, or display entities is depicted at 400. This type group may be defined by a user or system action that selects the group (e.g., via drag mouse action), wherein members are tagged globally as opposed to individual items within the members. For example, a user's desktop may include four application icons—Word, Power Point, Excel, and Visio. The user may select the collection of icons and group the icons under a global icon—Applications, which would then be the only icon appearing on the desktop with respect to applications. When the user selected the newly created icon, they could then use an axial control such as a mouse wheel to scroll through the respective applications (and select the desired application scrolled to, if desired). A display 410 also depicts an alternative aspect to the present invention. In this aspect, the item that has been scrolled as the top page is displayed in a larger manner (larger than thumbnail view) than the rest of the items appearing in the collection 400.

FIG. 5 illustrates collection rendering and scrolling options 500 in accordance with an aspect of the present invention. A diagram 510 illustrates that scrolling or cycling through image previews can occur in substantially any direction. This includes renderings and scrolling operations in three dimensions whereby scrolling appears to occur inward, outward or at an angular view from a given display perspective. For example, a vertical stack is shown at 520 with an elliptical item shown for preview. A circular view is depicted at 530 spreading in a horizontal manner, whereas a trapezoidal view 540 is displayed three dimensionally along an arbitrary axis. Also, a top down view 550 can be displayed and subsequently scrolled yet hiding other members or items in the collection.

It is to be appreciated that the present invention can employ substantially any coordinate system, including multidimensional coordinate systems, and employ substantially any display format, wherein the display format can include substantially any shape, color, sound, dimension (e.g., displaying list of items in 3 dimensions where different sounds are played as different items are scrolled), code format—including embedded executables, and include combinations of these and other respective formats or attributes. In addition, information retrieved from a database can be directed to substantially any portion of a display (not shown), wherein respective preview operations can occur. It is noted that display content can be transformed as it is rendered to the user. For example, the content or processed items of a collection can be scaled in a smaller or larger manner such as generating an iconic representation of the content or an expanded view of the content.

FIG. 6 illustrates alternative control options 600 in accordance with an aspect of the present invention. In this aspect, an alternative for scrolling individually through a collection of items is described. A stack of items is depicted at 610 having a depth indicating a plurality of members in the stack (e.g., 5000 items shown as a ½ inch stack). Rather than individually scrolling through each member, a curser or other control is moved down or up the side of the stack and stops arbitrarily at a position marked at 620 and as desired by the user. If a mouse is clicked, or the curser hovers for a predetermined amount of time at a position in the stack, the item at about the position marked at 620 can be moved (along with changing order of stack) to the front of the stack as illustrated at 630. The user can subsequently use a mouse wheel or other control to scroll the stack beginning at the position illustrated at 630. In this manner, large stacks can be navigated to an approximate starting position in a rough manner by a first movement, and subsequently scrolled in a finer-grained manner in a subsequent movement or control.

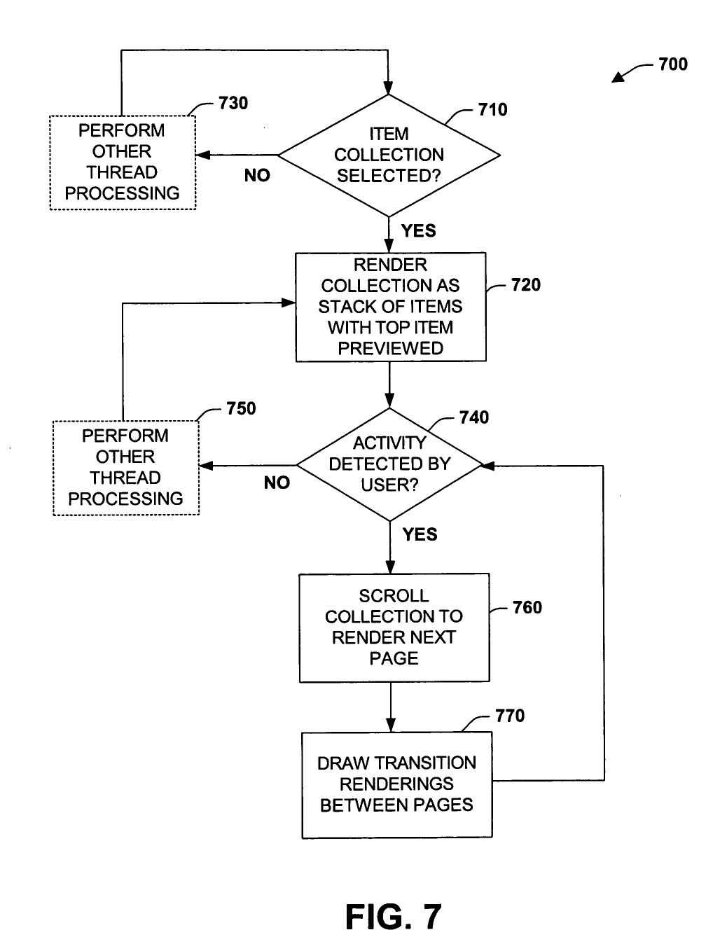

FIG. 7 is a methodology 700 illustrating axial control processing in accordance with an aspect of the present invention. While, for purposes of simplicity of explanation, the methodology is shown and described as a series of acts, it is to be understood and appreciated that the present invention is not limited by the order of acts, as some acts may, in accordance with the present invention, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the present invention.

Before proceeding, it is noted that the process 700 can be executed as a thread on a computer, wherein the tread can be executed during differing time slices such as during a background or foreground task. Thus, the various acts may be performed during all or portions of a single thread of execution or over multiple threads.

Proceeding to 710, a determination is made as to whether or not an item collection has been selected. If so, the process proceeds to 720. If not, the process proceeds to 730 and performs other thread processing before returning to 710. If the item collection is selected at 710, the process renders the top item in the stack as a preview at 720 (or other item such as bottom item) (e.g., thumbnail display of top item in the stack). At 740, another determination is made as to whether or not a user command is detected to cause the collection of items to be cycled (e.g., electronic, mechanical or verbal axial control). If not, the process proceeds to perform other thread processing and returns to 720. If a command is detected at 740, the process proceeds to 760 and scrolls the collection to render the next item or page in the collection. At 770, transition renderings can be previewed during the scrolling or cycling operation, wherein portions of pages or items can be displayed that indicate the transition from one page to the other.

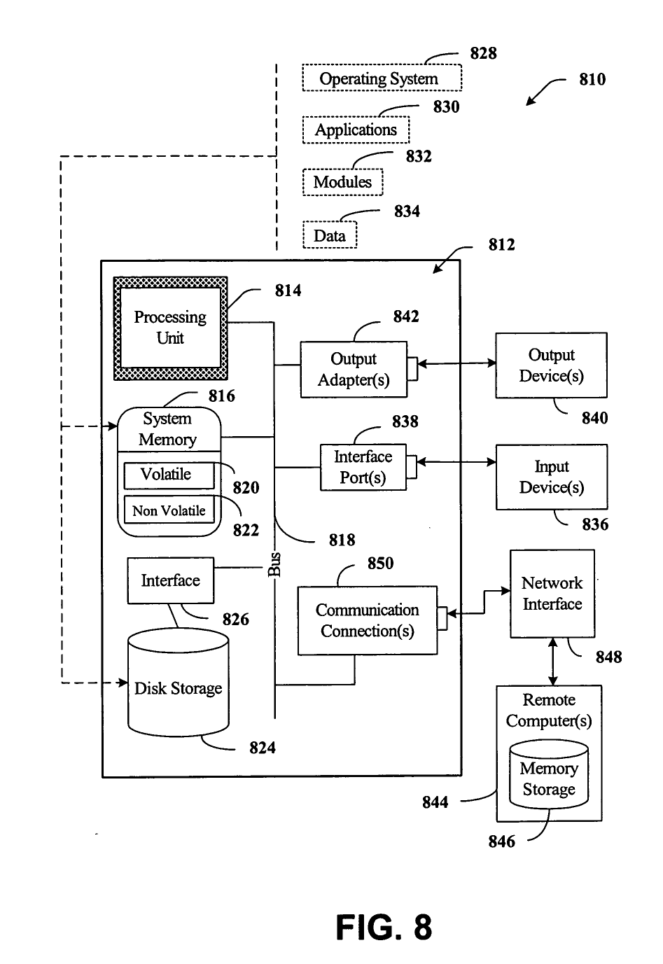

With reference to FIG. 8, an exemplary environment 810 for implementing various aspects of the invention includes a computer 812. The computer 812 includes a processing unit 814, a system memory 816, and a system bus 818. The system bus 818 couples system components including, but not limited to, the system memory 816 to the processing unit 814. The processing unit 814 can be any of various available processors. Dual microprocessors and other multiprocessor architectures also can be employed as the processing unit 814.

The system bus 818 can be any of several types of bus structure(s) including the memory bus or memory controller, a peripheral bus or external bus, and/or a local bus using any variety of available bus architectures including, but not limited to, 16-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 816 includes volatile memory 820 and nonvolatile memory 822. The basic input/output system (BIOS), containing the basic routines to transfer information between elements within the computer 812, such as during start-up, is stored in nonvolatile memory 822. By way of illustration, and not limitation, nonvolatile memory 822 can include read only memory (ROM), programmable ROM (PROM), electrically programmable ROM (EPROM), electrically erasable ROM (EEPROM), or flash memory. Volatile memory 820 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 812 also includes removable/non-removable, volatile/non-volatile computer storage media. FIG. 8 illustrates, for example a disk storage 824. Disk storage 824 includes, but is not limited to, devices like a magnetic disk drive, floppy disk drive, tape drive, Jaz drive, Zip drive, LS-100 drive, flash memory card, or memory stick. In addition, disk storage 824 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 824 to the system bus 818, a removable or non-removable interface is typically used such as interface 826.

It is to be appreciated that FIG. 8 describes software that acts as an intermediary between users and the basic computer resources described in suitable operating environment 810. Such software includes an operating system 828. Operating system 828, which can be stored on disk storage 824, acts to control and allocate resources of the computer system 812. System applications 830 take advantage of the management of resources by operating system 828 through program modules 832 and program data 834 stored either in system memory 816 or on disk storage 824. It is to be appreciated that the present invention can be implemented with various operating systems or combinations of operating systems.

A user enters commands or information into the computer 812 through input device(s) 836. Input devices 836 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 814 through the system bus 818 via interface port(s) 838. Interface port(s) 838 include, for example, a serial port, a parallel port, a game port, and a universal serial bus (USB). Output device(s) 840 use some of the same type of ports as input device(s) 836. Thus, for example, a USB port may be used to provide input to computer 812, and to output information from computer 812 to an output device 840. Output adapter 842 is provided to illustrate that there are some output devices 840 like monitors, speakers, and printers, among other output devices 840, that require special adapters. The output adapters 842 include, by way of illustration and not limitation, video and sound cards that provide a means of connection between the output device 840 and the system bus 818. It should be noted that other devices and/or systems of devices provide both input and output capabilities such as remote computer(s) 844.

Computer 812 can operate in a networked environment using logical connections to one or more remote computers, such as remote computer(s) 844. The remote computer(s) 844 can be a personal computer, a server, a router, a network PC, a workstation, a microprocessor based appliance, a peer device or other common network node and the like, and typically includes many or all of the elements described relative to computer 812. For purposes of brevity, only a memory storage device 846 is illustrated with remote computer(s) 844. Remote computer(s) 844 is logically connected to computer 812 through a network interface 848 and then physically connected via communication connection 850. Network interface 848 encompasses communication networks such as local-area networks (LAN) and wide-area networks (WAN). LAN technologies include Fiber Distributed Data Interface (FDDI), Copper Distributed Data Interface (CDDI), Ethernet/IEEE 1102.3, Token Ring/IEEE 1102.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 850 refers to the hardware/software employed to connect the network interface 848 to the bus 818. While communication connection 850 is shown for illustrative clarity inside computer 812, it can also be external to computer 812. The hardware/software necessary for connection to the network interface 848 includes, for exemplary purposes only, internal and external technologies such as, modems including regular telephone grade modems, cable modems and DSL modems, ISDN adapters, and Ethernet cards.

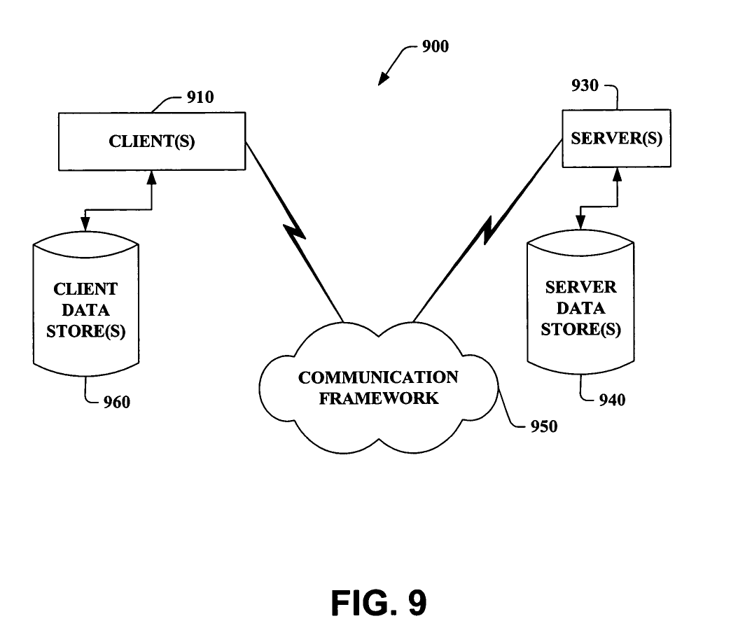

FIG. 9 is a schematic block diagram of a sample-computing environment 900 with which the present invention can interact. The system 900 includes one or more client(s) 910. The client(s) 910 can be hardware and/or software (e.g., threads, processes, computing devices). The system 900 also includes one or more server(s) 930. The server(s) 930 can also be hardware and/or software (e.g., threads, processes, computing devices). The servers 930 can house threads to perform transformations by employing the present invention, for example. One possible communication between a client 910 and a server 930 may be in the form of a data packet adapted to be transmitted between two or more computer processes. The system 900 includes a communication framework 950 that can be employed to facilitate communications between the client(s) 910 and the server(s) 930. The client(s) 910 are operably connected to one or more client data store(s) 960 that can be employed to store information local to the client(s) 910. Similarly, the server(s) 930 are operably connected to one or more server data store(s) 940 that can be employed to store information local to the servers 930.

What has been described above includes examples of the present invention. It is, of course, not possible to describe every conceivable combination of components or methodologies for purposes of describing the present invention, but one of ordinary skill in the art may recognize that many further combinations and permutations of the present invention are possible. Accordingly, the present invention is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A system for displaying item collection previews, comprising:
at least one display object having metadata tags that describe two or more data items in a collection of data items; and
a control component that selectively animates a presentation of the items based in part on the metadata tags and detected user activities.

2. The system of claim 1, further comprising one or more controller inputs to control the presentation of the items.

3. The system of claim 2, the controller inputs include at least one of a mouse curser control, a mouse wheel control, a voice command, an eye-gaze control, and a mechanical control to control the presentation of items.

4. The system of claim 1, the collection of data items further comprising a top item displayed as a thumbnail preview or an expanded size preview.

5. The system of claim 1, further comprising a control to provide a transitional animation that is employed to visually link movement of an axial controller with a change in a displayed icon.

6. The system of claim 1, further comprising a currently selected preview image that is integrated with a collection icon as a reminder of collection contents.

7. The system of claim 1, the control component further comprises at least one of an object locator, a command detector, a content analyzer, and a formatter to selectively animate the presentation of the items.

8. The system of claim 1, further comprising a graphical user interface to selectively animate the presentation of items.

9. The system of claim 8, the graphical user interface further comprising a set of preference controls that can change, by type of item, preview visualizations and access behaviors associated therewith.

10. The system of claim 1, the items include one or more subcomponents that can be previewed, selected, or displayed.

11. The system of claim 1, the items can be previewed in two dimensional or three dimensional form.

12. The system of claim 1, for comprising global controls for collecting unrelated items in a set of items to subsequently preview the items.

13. The system of claim 1, further comprising controls to scale the items to be previewed.

14. The system of claim 1, further comprising a control to determine a rough position in a collection of items.

15. A computer readable medium having computer readable instructions stored thereon for implementing at least one of the display object and the control component of claim 1.

16. A system that facilitates information preview from a collection, comprising:
means for displaying a set of information items;
means for selecting the set of information items;
means for detecting a value with respect to the set of information items; and
means for previewing the information items based upon incrementing or decrementing the value.

17. A method to facilitate information previews form a set of items, comprising:
selecting a stack of display items with a first control; and
cycling the stack of display items with a second control in order to provide an information preview with respect to at least one of the items.

18. The method of claim 17, further comprising providing a transitional display for at least two display items in accordance with the second control.

19. The method of claim 17, further comprising employing the first control to find an approximate position in the stack of display items.

20. The method of claim 17, the information preview is associated with at least one of a display that is about the same size as the stack, smaller than the stack, and larger than the stack.

21. The method of claim 17, the first control is associated with a curser which is controlled by a mouse and the second control is associated with a wheel of the mouse.

22. A graphical user interface, comprising:
a display object for displaying a group of pages;
a tag associated with each member page from the group of pages;
a curser to select the group of pages; and
an axial controller to cycle the group of pages.

23. The graphical user interface of claim 22, the axial controller causes a transition animation between pages when cycling the group of pages.
